(19) United States
(12) Patent Application Publication
(10) Pub. No.: US 2006/0212823 A1
(43) Pub. Date: Sep. 21, 2006

(54) Systems, methods and computer program products for configuring an assembly line

(76) Inventors: Rajesh M. Bhagat, Edison, NJ (US); Redha M. Bournas, Chapel Hill, NC (US); Vishwanath Narayan, Boca Raton, FL (US); David Noller, Blacksburg, VA (US); Paul D. Peters, Woodbury, CT (US); David J. Salkeld, Raleigh, NC (US)

Correspondence Address: David Beatty;Myers Bigel Sibley & Sajovec, P.A., Post Office Box 37428, Raleigh, NC, 27627, US

(21) Appl. No.: 11/081,898

(22) Filed: Mar. 16, 2005

(51) Int. Cl. G05B 11/01

(52) U.S. Cl. 715/783; 700/11; 700/17; 700/95

(57) ABSTRACT

A system for graphically and dynamically configuring an assembly line having process points where events can be triggered, includes: a service configurator for configuring services including imported Web Services; and a process configurator for configuring processes to be implemented in response to triggered events at the process points, wherein each of the processes comprises a sequenced list of the services to be invoked in response to the triggered event.

### BACKGROUND OF THE INVENTION

In general, the present invention provides a system, graphical user interface (GUI), method and computer program product for graphically and dynamically configuring an assembly line.

Assembly lines have long been used to provide an automated way to manufacture a line of goods such as automotive components, electronic components, etc. In today's world, an assembly line generally includes work “cells” that are logically referred to as “process points.” Each process point performs a specific operation as a good passes through a line. For example, one process point could be responsible for painting the exterior of an automobile, while another could be responsible for putting tires on the automobile. The work performed at each process point is usually the same for all goods passing through the line. Moreover, work performed at a process point could be associated with one or more computer processes. In such cases, an operator at the process point will trigger the computer process using a device connected to a central computer that controls the line. Alternatively, the computer process could be triggered automatically as a good reaches the process point. In either event, the results of the computer process will either be returned to the process point device, stored in a local database system, or forwarded to another system.

In today's manufacturing environment, work cells and process points are statically configured with the central computer. That is, the assembly line configuration is defined before the goods are assembled, and will remain unchanged throughout the complete assembly of goods. The central computer will typically use a hard-coded file to identify requests coming from the work cells, and associate the requests with processes to perform their functions. The hard-coded file is linked with computer software to run the assembly line prior to starting the assembly of goods. Hence, if a computer device fails while executing a work cell process, it will not be possible to reconfigure the work cell to replace the failed device by an operable device and resume operation of the line. Accordingly, the current static methodology can lead to a considerable waste of time and resources.

### BRIEF SUMMARY OF THE INVENTION

According to embodiments of the present invention, a system for graphically and dynamically configuring an assembly line having process points where events can be triggered, includes: a service configurator for configuring services including imported Web Services; and a process configurator for configuring processes to be implemented in response to triggered events at the process points, wherein each of the processes comprises a sequenced list of the services to be invoked in response to the triggered event.

According to further embodiments of the present invention, a computer-implemented method for graphically and dynamically configuring an assembly line having process points where events can be triggered, includes: graphically configuring services including imported Web Services; and graphically configuring processes to be implemented in response to triggered events at the process points, wherein each of the processes comprises a sequenced list of the services to be invoked in response to the triggered event.

According to embodiments of the present invention, a computer program product for implementing a production process includes a computer readable medium having computer readable program code embodied therein, the computer readable program code comprising: computer readable program code configured to configure services comprising imported Web Services; and computer readable program code configured to configure processes to be implemented in response to triggered events at the process points, wherein each of the processes comprises a sequenced list of the services to be invoked in response to the triggered event.

According to further embodiments of the present invention, a system for graphically and dynamically configuring an assembly line having process points where events can be triggered, includes a version configurator for selecting between at least: creating a new assembly line for configuring; and selecting a pre-existing assembly line for configuring.

Further features and details of the present invention will be appreciated by those of ordinary skill in the art from a reading of the figures and the detailed description of the embodiments that follow, such description being merely illustrative of the present invention.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 depicts a system for graphically and dynamically configuring an assembly line of goods according to the present invention.

FIG. 2 depicts the configuration system of FIG. 1 in greater detail.

FIGS. 3A and 3B depict illustrative interface pages for configuring a version of the assembly line.

FIGS. 4A and 4B depict illustrative interface pages for configuring the assembly line as a tree or hierarchy of categories according to an aspect of the present invention.

FIGS. 5A-5D depict illustrative interface pages for configuring messages according to an aspect of the present invention.

FIGS. 6A and 6B depict illustrative interface pages for configuring services according to an aspect of the present invention.

FIGS. 7A-7C depict illustrative interface pages for configuring processes according to an aspect of the present invention.

FIGS. 8A-8D depict illustrative interface pages for configuring process points according to an aspect of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the following terms shall have the following meanings:

Process Point—A “process point” is a place where manufacturing activities are performed to produce or transform a product. A process point is typically a logical location in a “shop.” An assembly line is generally a collection of process points.

Event—An “event” is a trigger at a process point and is typically associated with a Work in Progress (WIP) movement, manufacturing activities like part installation, detection of exceptional condition, etc. An event may be triggered from a device, a person (e.g., via a terminal), a sub-system (e.g., quality information collection system), etc.

Action—An “action” is a function (e.g., of a Manufacturing Execution System (MES)) to support operations. It is a unit of work and, hence, any actions can be combined within a single process independently. Most actions are reusable and are used in different process points repeatedly. For instance, a “broadcast action” may be used in multiple process points to distribute manifest papers to different shops.

Service—A “service” is a computer implementation of an action. In accordance with embodiments of the present invention, actions are implemented by Web Services, which may be internal or external.

Manufacturing Process (or Process)—A “process” is a sequential set of services to be invoked by the Assembly Line Controller (ALC) in response to a triggering event. Each process may have different set of services.

Message—A “message” is a set of attributes (e.g., specification by name, type and value) associated with a process either as input or output.

Web Service—“Web Services” are Internet and intranet-based, self-contained, modular applications that perform specific tasks, and are initiated automatically by programs through the use of Internet standard technologies. Web Services employ interactions (e.g., binding, finding, etc.) implemented by the exchange of extensible Markup Language (XML) messages. Web Services make it possible to integrate systems that would otherwise require extensive development efforts. Web Services provide a simple and streamlined mechanism for applications to communicate over the Internet/intranet using established standards and technologies and without human intervention (i.e., program to program interaction), and without the need to know the environment at each end point.

Web Services Description Language (WSDL)—WSDL is an XML format for describing network services as a set of endpoints operating on messages containing either document-oriented or procedure-oriented information. The operations and messages are described abstractly, and then bound to a concrete network protocol and message format to define an endpoint. Related concrete endpoints are combined into abstract endpoints (services). WSDL is extensible to allow description of endpoints and their messages regardless of what message formats or network protocols are used to communicate. According to some embodiments, the WSDL is used in conjunction with SOAP, HTTP GET/POST, and MIME.

Business Process Execution Language (BPEL)—BPEL is an XML-based language that enables the formal specification of business processes and business interaction protocols. By doing so, it extends the Web Services interaction model and enables it to support business transactions. BPEL defines an interoperable integration model that should facilitate the expansion of automated process integration in both the intra-corporate and the business-to-business spaces.

Name space—“Name spaces” are second level identifier names that enable one to specify two messages with the same name but with different name spaces.

The Internet—As is well known, the Internet is a computer network consisting of a worldwide network of computer networks that use the TCP/IP network protocols to facilitate data transmission and exchange.

The present invention provides a system, GUI, method and program product for graphically and dynamically configuring an assembly line of goods using Web Services. Specifically, under the present invention, a GUI is provided that allows an assembly line to be both graphically and dynamically configured. In general, the GUI allows a designer or the like to “graphically” configure: a hierarchy of categories representing the assembly line; the process points along the assembly line; the services that are taken in response to triggering events at the process points; the different processes (flow of services) that can be invoked as a result of the events at the process points; and the input and output messages associated with the events. The GUI may also allow the designer to graphically select an existing version of an assembly line or initiate the creation of a new assembly line configuration. According to some embodiments, the GUI is maintained on a system that is separate from the central computer controlling the assembly line. This not only allows the assembly line to be configured remotely, but also without ceasing operation of the line.

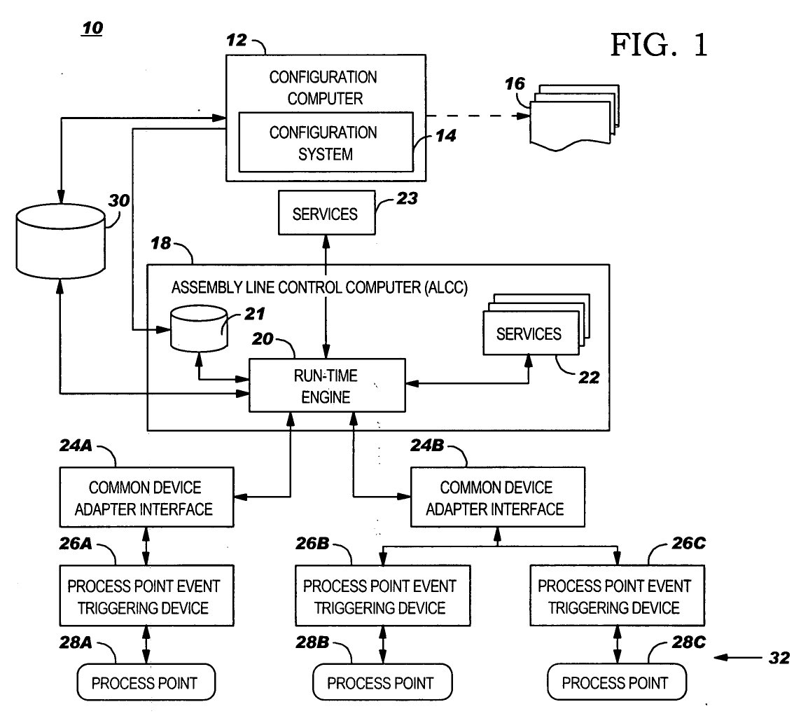

Referring now to FIG. 1, a system 10 for configuring an assembly line 32 is shown. As indicated above, assembly lines are typically a collection of work cells. Each work cell is logically referred to as a process point, which (as indicated above) is a place where manufacturing activities are performed to produce or transform a product. In the illustrative example shown in FIG. 1, the assembly line 32 includes process points 28A-C. The system 10 further includes an assembly line control computer (ALCC) 18, which itself includes a deployment or run-time engine 20. The run-time engine 20 is connected to a run-time database 21, internal services 22 (e.g., via intranet), and external services 23 (e.g., via the Internet). According to some embodiments, the run-time engine 20 employs and executes BPEL processes.

As the process points 28A-C are performing their assigned tasks, certain events will occur. As known, an event is typically associated with a Work in Progress (WIP) movement, manufacturing activities, the detection of an error condition, etc. Events can be triggered in a number of ways such as by process point triggering devices 26A-C (as shown in FIG. 1 for illustrative purposes), personnel (e.g., via terminals), via sub-systems (e.g., quality information collection systems), etc. As events are triggered, they will be communicated to the run-time engine 20 via common device adapter interfaces 24A-B (collectively, an input/output interface). As further shown in FIG. 1, multiple triggering devices 26B-C and process points 28B-C can share a common device adapter interface 24B. Upon receiving notification of an event, the run-time engine 20 will attempt to determine a set of services 22, 23 that should be invoked in response.

Advantageously, the system 10 enables a designer or the like to dynamically configure the assembly line 32 via a configuration computer 12. That is, the configuration of the assembly line 32 is provided independent of the ALCC 18. The configuration computer 12 includes a configuration system 14 which includes a build-time engine and provides a GUI (e.g., a set of interface pages) 16 for graphically configuring the assembly line 32. This configuration can be stored in a build-time database or storage unit 30 for subsequent access by the ALCC 18 and/or subsequent modification via the configuration system 14. Portions of this configuration may be deployed to the run-time database 21 (directly or via the run-time engine 20) for use by the run-time engine 20.

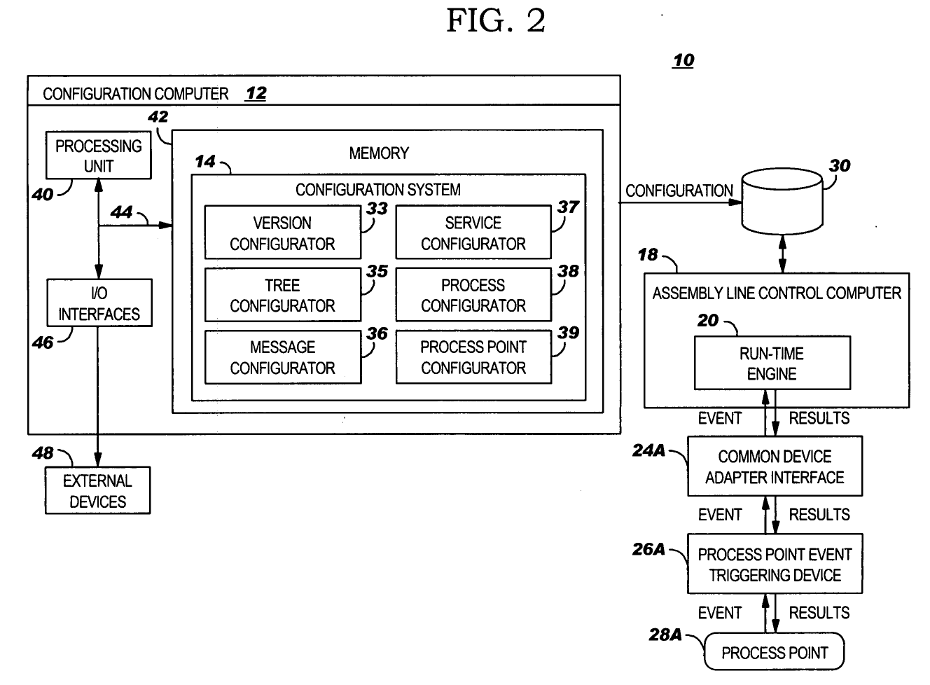

Referring to FIG. 2, a more detailed diagram of the configuration computer 12 is shown therein. FIG. 2 depicts only a single process point 28A, process point triggering device 26A and common device adapter interface 24A for simplicity. These single elements will be used below to describe a particular illustrative example. Nevertheless, the configuration computer 12 is intended to represent any type of computer that is capable of carrying out the functions of the present invention. For example, the configuration computer 12 could be a desktop computer, a laptop, a workstation. Moreover, the configuration of the assembly line 32 can occur on a stand-alone configuration computer or over a network. In the case of the latter, the configuration computer 12 could be a client or a server. Also, the network could be any type of network such as the Internet, a local area network (LAN), a wide area network (WAN), a virtual private network (VPN), etc. Communication throughout the network could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity.

As depicted, the configuration computer 12 generally includes a processing unit (CPU) 40, memory 42, a bus 44, input/output (I/O) interfaces 46, and external devices/resources 48. The CPU 40 may comprise a single processing unit, or be distributed across one or more processing units in one or more locations, e.g., on a client and server. The memory 42 may comprise any known type of data storage and/or transmission media, including magnetic media, optical media, random access memory (RAM), read-only memory (ROM), a data cache, a data object, etc. Moreover, similar to the CPU 40, the memory 42 may reside at a single physical location, comprising one or more types of data storage, or be distributed across a plurality of physical systems in various forms.

The I/O interfaces 46 may comprise any system for exchanging information to/from an external source. The external devices/resources 48 may comprise any known type of external device, including speakers, a CRT, LED screen, hand-held device, keyboard, mouse, voice recognition system, speech output system, printer, monitor/display, facsimile, pager, etc. The bus 44 provides a communication link between each of the components in the configuration computer 12 and likewise may comprise any known type of transmission link, including electrical, optical, wireless, etc.

The build-time storage unit 30 can be any system (e.g., a database, etc.) capable of providing storage for information under the present invention. As such, the storage unit 30 could include one or more storage devices, such as a magnetic disk drive or an optical disk drive. In another embodiment, the storage unit 30 includes data distributed across, for example, a local area network (LAN), wide area network (WAN) or a storage area network (SAN) (not shown). Although not shown, additional components, such as cache memory, communication systems, system software, etc., may be incorporated into configuration computer 12. In addition, it should be understood that the ALCC 18 will likely include computerized components similar to the configuration computer 12. Such components have not been shown for simplicity.

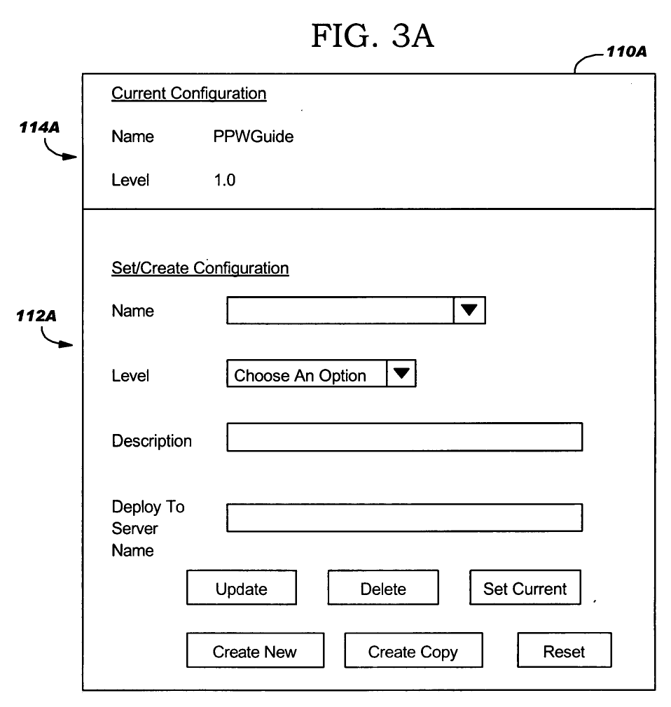

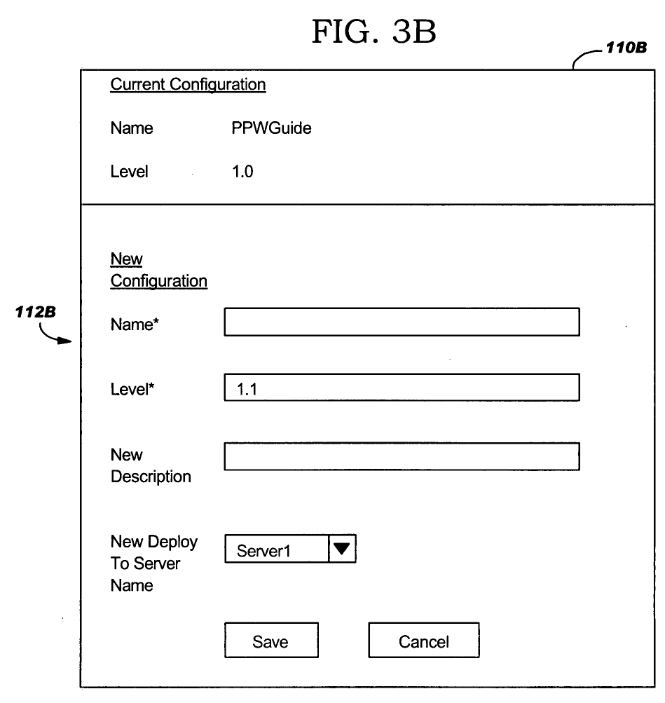

Shown in the memory 42 is the configuration system 14, which includes a version configurator 33, a tree configurator 35, a message configurator 36, a service configurator 37, a process configurator 38, and a process point configurator 39. The functions of each of these configurators will be further described below in conjunction with FIGS. 3-8. However, in general, each of these configurators typically provides at least one interface page for allowing dynamic and graphical configuration of the assembly line by an authorized configuring user or the like (not shown). As the assembly line is configured, the configuration details will be stored in one or more tables within the storage unit 30 and the run-time database 21 for subsequent access by the ALCC 18 and, more particularly, the run-time engine 20. It should be appreciated that the manner in which configurators are shown within the configuration system 14, and the order in which they are described below, is intended for illustrative purposes only and is not meant to limit the present invention. That is, the various configurators could be shown in any manner and described in any order.

According to some embodiments, a user with an authorized role must first choose a line configuration version to work with during the current session prior to performing any tasks. The version configurator 33 can be used to create an empty new version of a line configuration, copy the contents of an existing line configuration version to a new one, delete an existing line configuration version, or select an existing line configuration version to edit in the current session. A line configuration version consists of a line configuration, its associated messages, services, processes and configuration of process points.

Referring now to FIGS. 3A and 3B, an illustrative version configuration interface page 110A as provided by the version configurator 33 is shown in FIG. 3. As depicted, the interface page 110A includes a portlet 112A. Using the interface page 110A, the following functions can be performed:

Creating a new line configuration version—In the portlet 112A, the user enters the name, level and description of the line configuration to be created in the corresponding fields. The user also enters in the “Deploy To Server Name” field an appropriate name to specify the server to which the configuration data will be directed upon deployment, and clicks the “Create New” button.

Copying from an existing line configuration version—In the portlet 112, the user first selects the version to copy from the “Name” and “Level” pull down menus, and then clicks on the “Create Copy” button. The existing line configuration may be copied from the build-time database 30. The interface page 110A is then replaced with a revised interface page 110B having a portlet 112B as shown in FIG. 3B. In the portlet 112B, the user then enters the name, level and description for the new configuration in the appropriate fields, selects the appropriate sewer from the “New Deploy to Server Name” pull down menu, and clicks “Save.”

Deleting an existing line configuration version—In the portlet 112A (FIG. 3A), the user selects the name and the level of the version to be deleted using the “Name” and “Level” pull down menus, and then clicks on the “Delete” button.

Selecting the working line configuration version (i.e., the line configuration version to be built or edited in the current session)—In the portlet 112A, the user selects the name and the level of the version to work on in this session using the “Name” and “Level” pull down menus, and clicks on the “Set Current” button in the portlet 112A.

During use, the interface page 110A will list the currently designated working line configuration and level (if any) in the upper portion of the interface page. The user may reset the interface page 110A and undesignate the currently designated working line configuration and level by clicking on the “Reset” button in the portlet 112A.

The tree configurator 35 is used to define where each process fits into a hierarchy of categories, such as plant location or assembly line zone. For example, this hierarchical tree can be a valuable representation of the integration points of a manufacturing floor with manufacturing applications such as Quality, Inspection, Material Management, Error Proofing, Replenishment, Order Management and others, and may provide a centralized integration system. Each process point of the line configuration will be defined as a category node using the tree configurator 35 or by pre-designation (e.g., copied from an earlier version). Some categories may not have processes attached thereto.

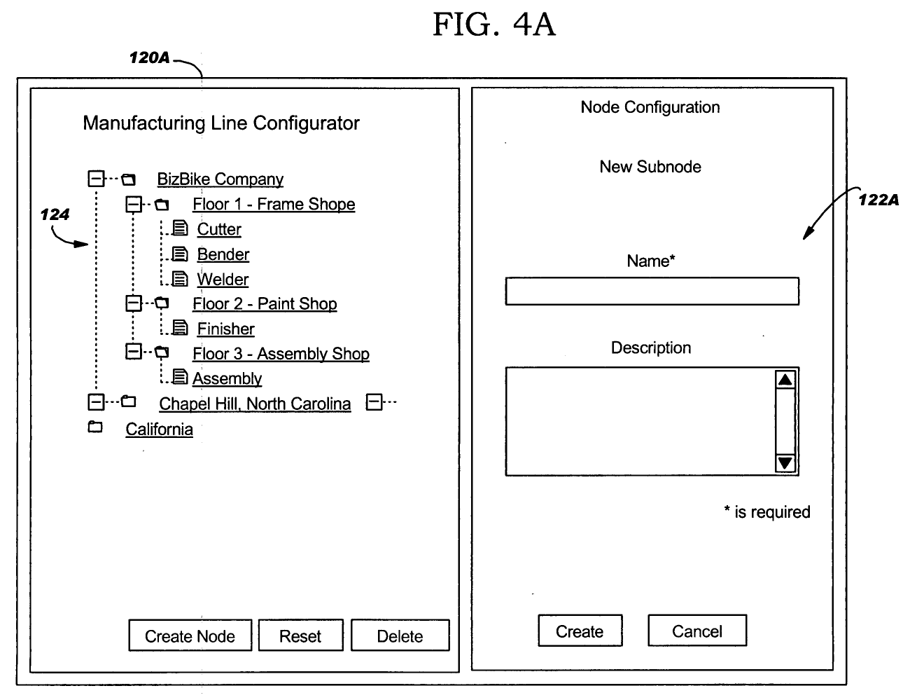

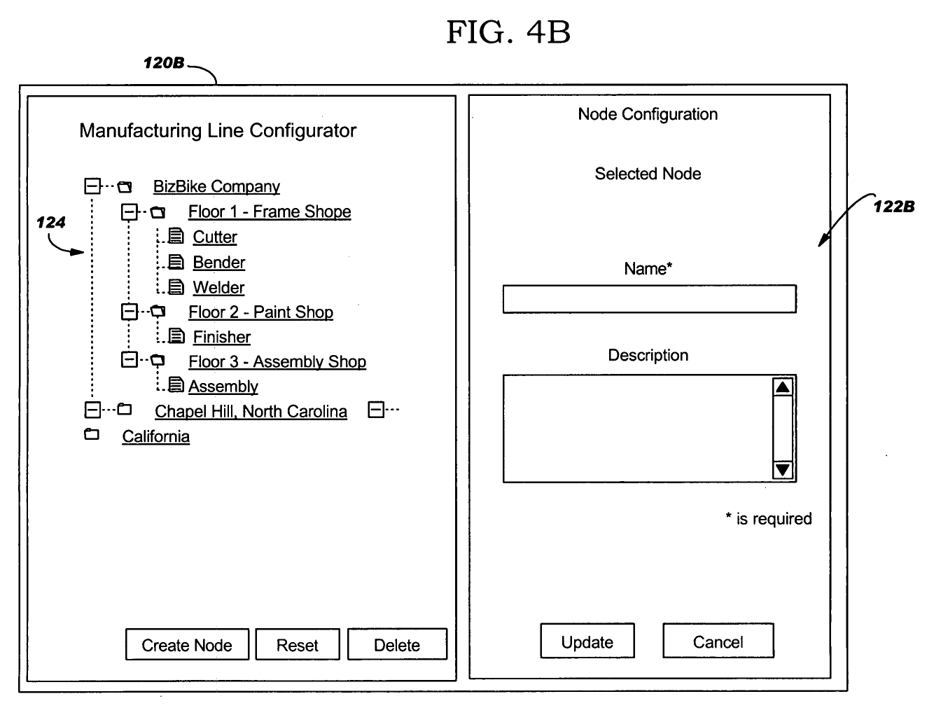

Referring now to FIGS. 4A and 4B, illustrative tree configuration interface pages 120A (FIG. 4A) and 120B (FIG. 4B) as provided by the tree configurator 35 are shown. As depicted, the interface pages 120A, 120B each include an up to date hierarchical tree portlet 124 including a representation of the assembly line. The interface pages 120A and 120B also include respective portlets 122A and 122B. Using the interface pages 120A, 120B, the following functions can be performed:

Creating a new category—To perform this task, the configuring user will use the tree portlet 124 to identify and select the parent node of the new category node to be inserted (i.e., the node under which the new category node is to be inserted) by clicking on the parent node in the tree portlet 124 and then clicking “Create Node” in the portlet 124, responsive to which the interface page 122A is displayed. The new category node may be a process point. The user then enters the name and a description of the new category in the corresponding fields of the portlet 122A. The user then clicks the “Create” button in the portlet 122A.

Updating an existing category—To perform this function, the configuring user will locate and click on the category/node to be updated in the tree portlet 124 to select the category, which may be a process point. In response, the information corresponding to the selected node is automatically displayed in the appropriate fields of the portlet 122B of the interface page 120B. The user then enters the needed updates in the “Name” and “Description” fields of portlet 122B, and clicks the “Update” function button in the portlet 122B.

Deleting an existing category—To perform this task the configuring user will locate and click on the category/node to be deleted in the tree portlet 124 to select the category (which may be a process point), and click the “Delete” button in the portlet 124.

The user may reset the tree configuration interface page 120 by clicking on the “Reset” button in the portlet 124.

The message configurator 36 is used to define the input and output messages to be associated with processes. Each process is associated with exactly one input message and exactly one output message. Each of the input and output messages contains a respective set of attributes, which, according to some embodiments, is defined by name, type and value. An input message specifies the input data to be received or consumed as input(s) by a process associated with an event. An output message specifies the output data to be produced as output(s) by the process associated with the event. According to some embodiments, the messages are XML name spaces and have values that are Uniform Resource Identifiers (URIs). The name spaces could be any names.

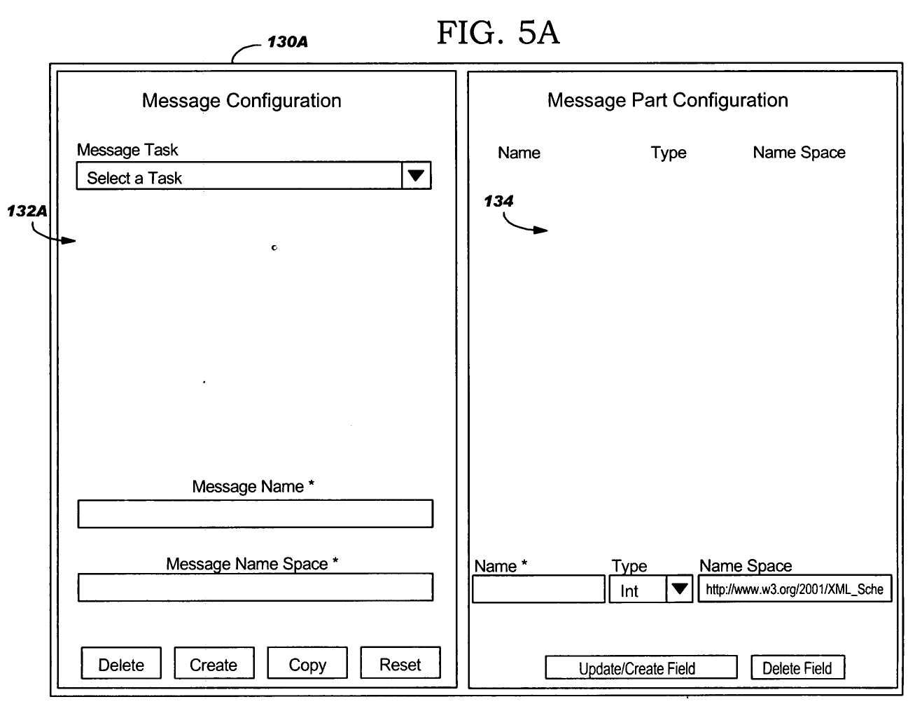

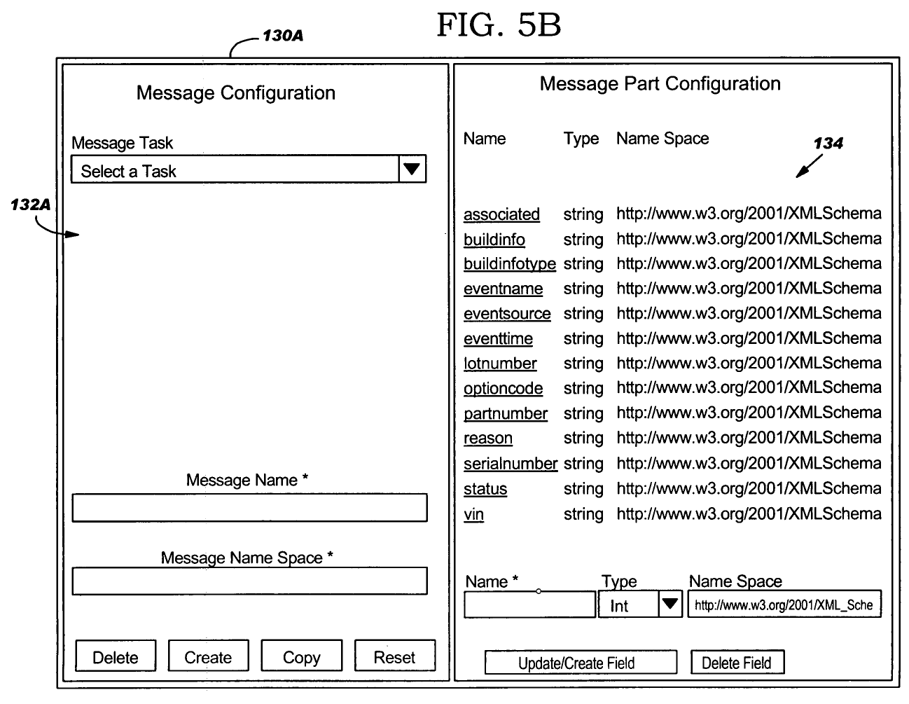

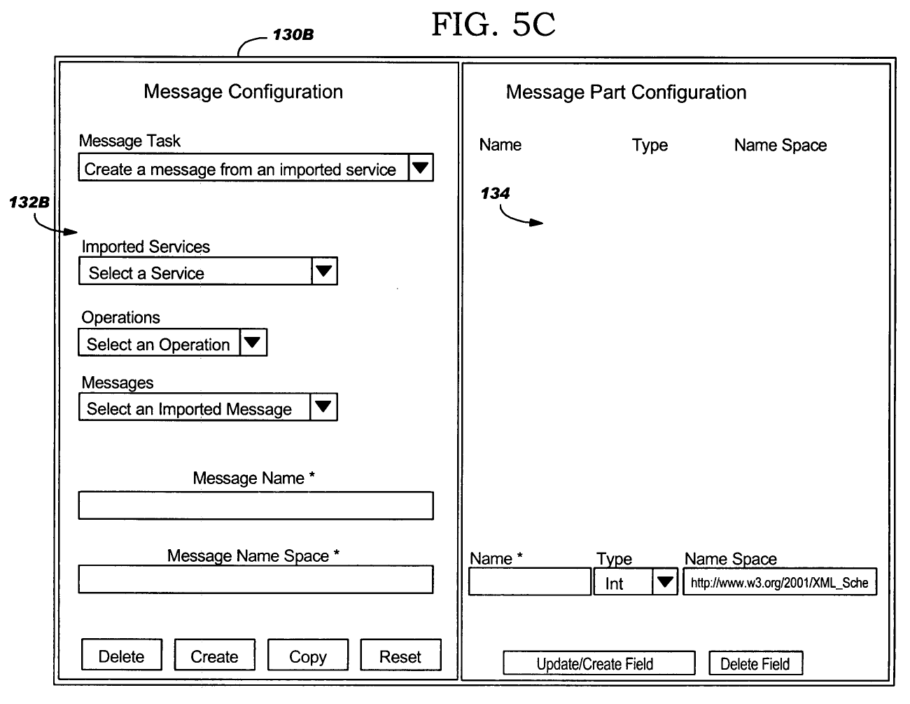

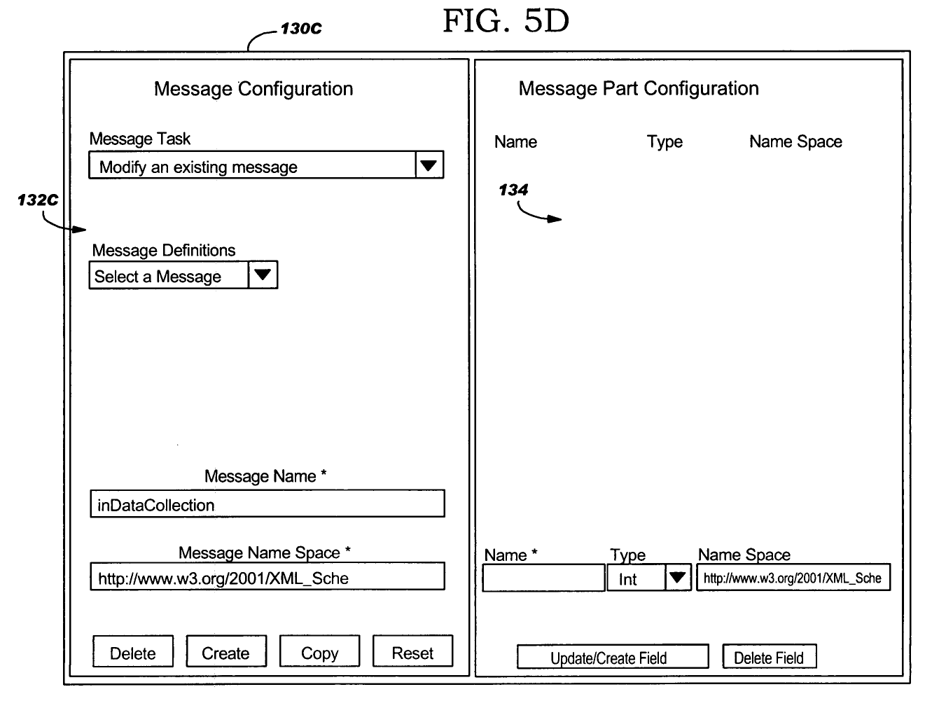

Referring now to FIGS. 5A-5D, illustrative message configuration interface pages 130A, 130B, 130C as provided by the message configurator 36 are shown therein. The interface page 130 includes portlets 132A, 134. The interface page 130B replaces the portlet 132A with a portlet 132 and the interface page 130C replaces the portlet 132A with a portlet 132C. Using the interface pages 130A, 130B, 130C, the following functions can be performed:

Creating a new message—In the portlet 132A of the interface page 130A (FIG. 5A), the user selects the option “Create a message from scratch” from the “Message Task” pull down menu, enters a name and description in the corresponding fields, and clicks “Create”. In the portlet 134, the user then specifies the name, type and name space for each attribute to be added either by 1) directly editing the table displayed in the portlet 134, or 2) entering the name, type and name space of each attribute in the “Name,” “Type”, and “Name Space” fields at the bottom of the portlet 134. The user clicks “Update/Create Field” after each attribute entry. The attributes will be displayed in the portlet 134 as shown in FIG. 5B.

Creating a message from an imported service—In the portlet 132A (FIG. 5A), the user selects the option “Create a message from an imported service” from the “Message Task” pull down menu list. The interface page 130A is automatically replaced by the interface page 130B (FIG. 5C). In the portlet 132B, the user then selects a service from the “Imported Services” menu, selects an operation from the “Operations” menu, selects a message from the “Messages” menu, and enters a message name and a message name space in the corresponding fields. The services listed in the “Imported Services” menu may be, for example, previously configured services. The user then clicks the “Create” button. Thereafter, the user can add and specify attributes for the imported messages in the same manner as described above using the portlet 134. For any attributes listed in the table that the user does not wish to retain in the message definition, the user may click the attribute and then click “Delete” to remove the attribute from the message definition.

Updating an existing message—In the portlet 132A (FIG. 5A), the user selects “Modify an existing message” from the “Message Task” pull down menu, which causes the interface page 130A to be replaced with the interface page 130C (FIG. 5D) having a portlet 132C in place of the portlet 132A. In the portlet 132C, the user selects the message to be updated from the “Message Definitions” pull down menu. Thereafter, the user can modify any attributes by clicking the attribute name in the portlet 134, making the necessary changes in the “Name”, “Type” and “Name Space” fields, and thereafter clicking “Update/Create Field”. An attribute can be removed by selecting the attribute in the portlet 134 and clicking “Delete.”

Deleting a message—The user selects “Modify an existing message” from the “Message Task” menu in the portlet 132C (FIG. 5D), selects the message to be deleted from the “Message Definitions” list, and clicks “Delete.”

According to some embodiments, the name of any existing message cannot be changed once it is created. That is, if a change is made to the name of an existing message, a new message is created with the new name but the original message remains with the original name until deleted. According to some embodiments, it is not possible to update or delete a message that is associated with a process.

The service configurator 37 is used to define a service catalog including a listing of Web Services. More particularly, the service configurator is used to define service categories in a tree structure and to import the Web Services definitions (as Web Service Definition Language (WSDL) documents) corresponding to the Web Services from specified Uniform Resource Locator addresses (URLs). A service can also be an internally implemented Enterprise JavaBeans (EJB). An authorized user defines the services that can be invoked by the ALCC 18 and, more particularly, the run-time engine 20, as a result of events (e.g., events sent from the plant floor). A service is implemented either as an internal Web Service (i.e., implemented in the ALCC 18 or a local network, e.g., across the Internet) or an external Web Service (i.e., implemented outside the ALCC 18 or the local network).

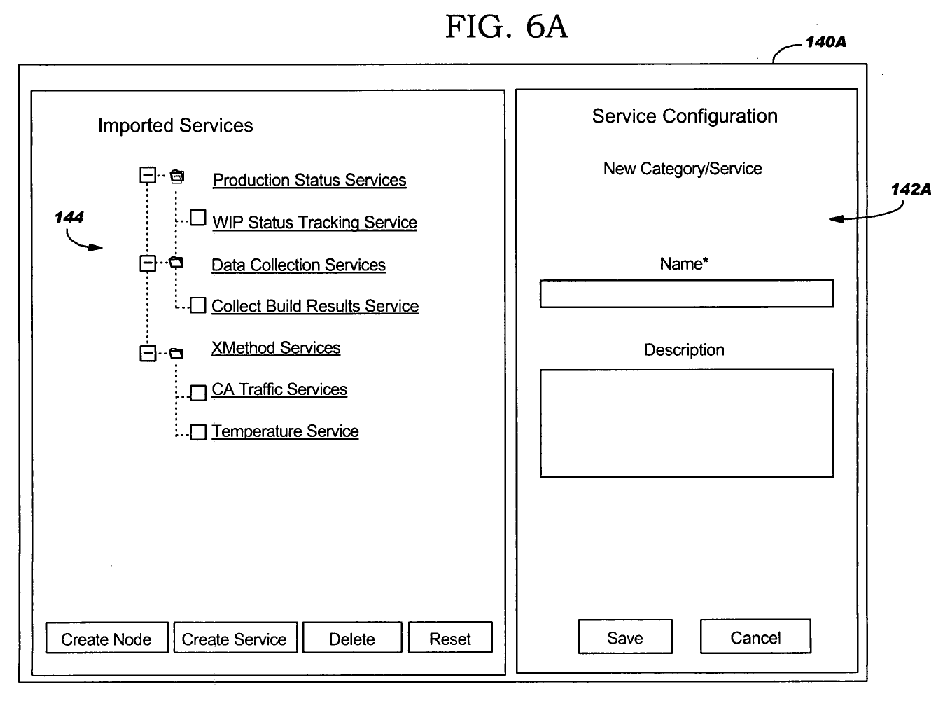

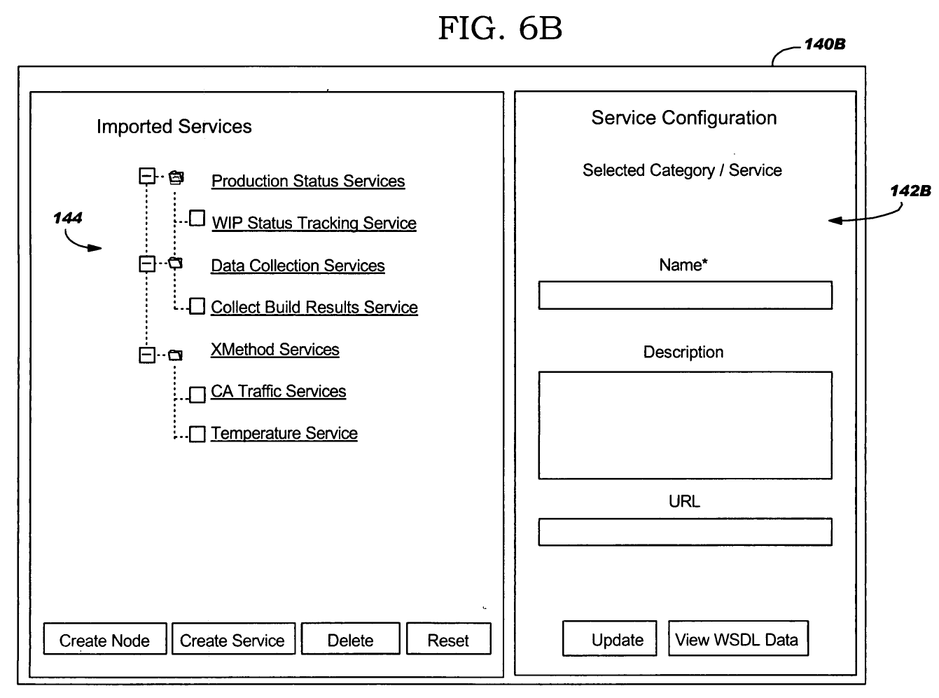

Referring now to FIGS. 6A and 6B, illustrative service configuration interface pages 140A, 140B as provided by the service configurator 37 are shown. As depicted, the interface page 140A includes portlets 142A and 144 and the interface page 140B includes the portlet 144 and a portlet 142B. Using the interface pages 140A, 140B, the following functions can be performed:

Creating a new service category—In the tree of the portlet 144, the user clicks on the parent category listing under which the user wishes to create a child sub-category (if the tree is empty, then by default the parent is the root of the tree) and clicks the “Create Node” button. The user then enters the name and a description of the new service category in the “Name” and “Description” fields of the portlet 142A. The user then clicks on the “Save” button in the portlet 142A.

Updating an existing service category—In the tree of the portlet 144, the user clicks on the listing of the service category to be updated, responsive to which the information corresponding to the selected service category is automatically displayed in the appropriate fields of the portlet 142B of the interface page 140B. In the portlet 142B, the user then revises the name and/or description of the selected service category in the “Name” and “Description” fields and clicks on the “Update” button.

Deleting a service category—In the tree of the portlet 144, the user clicks on the listing of the service category to be deleted. The user then clicks on the “Delete” button in the portlet 144.

Creating a new service—In the tree of the portlet 144, the user clicks on the listing of the service category under which to create the new service, and then clicks the “Create Service” button. The interface page 140B (FIG. 6B) is automatically called up and displayed. The user then enters the name, description of the service, and the Universal Resource Locator (URL) from which the Web Service definition (WSDL document) is to be imported in the “Name”, “Description”, and “URL” fields of the portlet 142B and clicks on the “Save” button. The WSDL document is then automatically imported by the configuration system 14 via Internet transfer of data using the specified URL.

Updating an existing service—In the tree of the portlet 142, the user clicks on the listing of the service to be updated, responsive to which the information corresponding to the selected service is automatically displayed in the appropriate fields of the portlet 142B of the interface page 140B. The user then revises the name, description and/or the URL in the “Name”, “Description”, and/or “URL” fields of the portlet 142B, and clicks on the “Update” button. The WSDL document is then automatically imported by the configuration system 14 via Internet transfer of data using the specified URL. Also, the user can simply click on the “Update” button to reload the WSDL document.

Deleting a service—In the tree of the portlet 144, the user clicks on the listing of the service to be deleted. The user then clicks on the “Delete” button.

Additionally, the user may click on a listing of a service of interest in the tree of the portlet 144 and thereafter click on the “View WSDL Data” button in the portlet 142B. The service configurator 37 will then display the WSDL data on another interface page or window.

Referring back to FIG. 2, the process configurator 38 is used to define the processes that are to be carried out as the result of events created by the assembly line process points. Each process contains a sequential list of services for the ALCC 18 to invoke as a result of a triggered event. A user uses the process configurator 38 to specify a list of services to be invoked for each process (which may be new or pre-existing). To confirm a process, the user assigns exactly one input message and exactly one output message to the process itself, as well as an input message and an output message to each service in the process. The process configurator 38 provides graphical representation and may allow the re-use of defined processes in the configuration of other assembly lines, the ability to re-configure a process of an existing assembly line, and/or the ability to disable a process from an existing configuration.

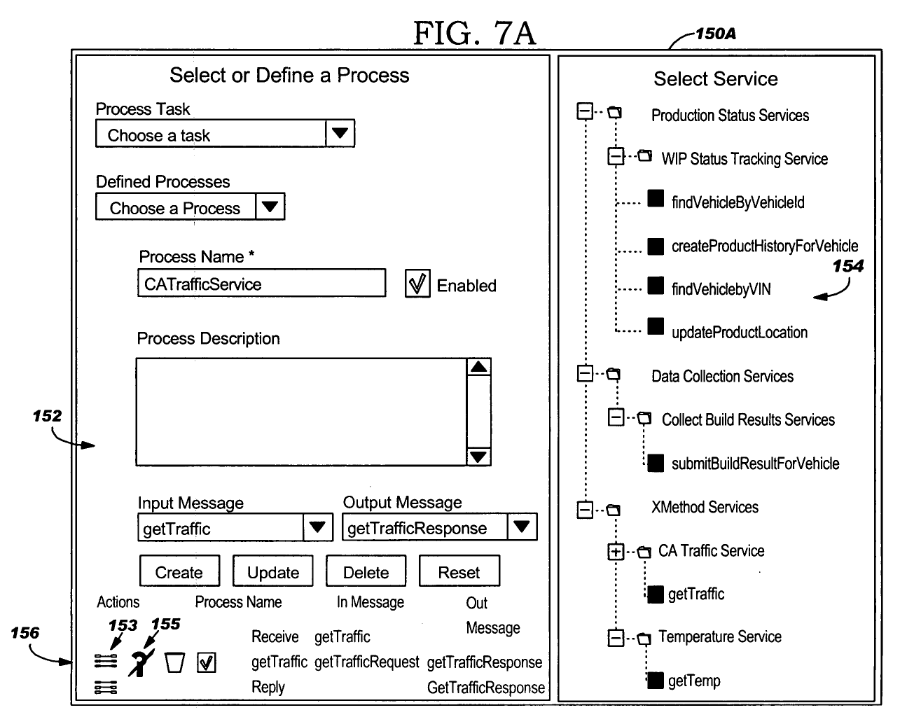

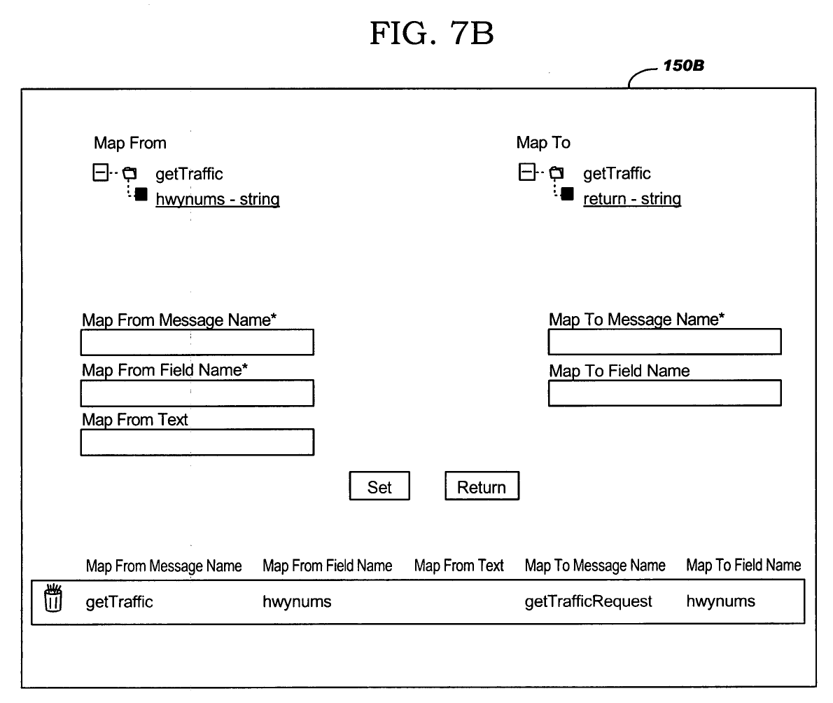

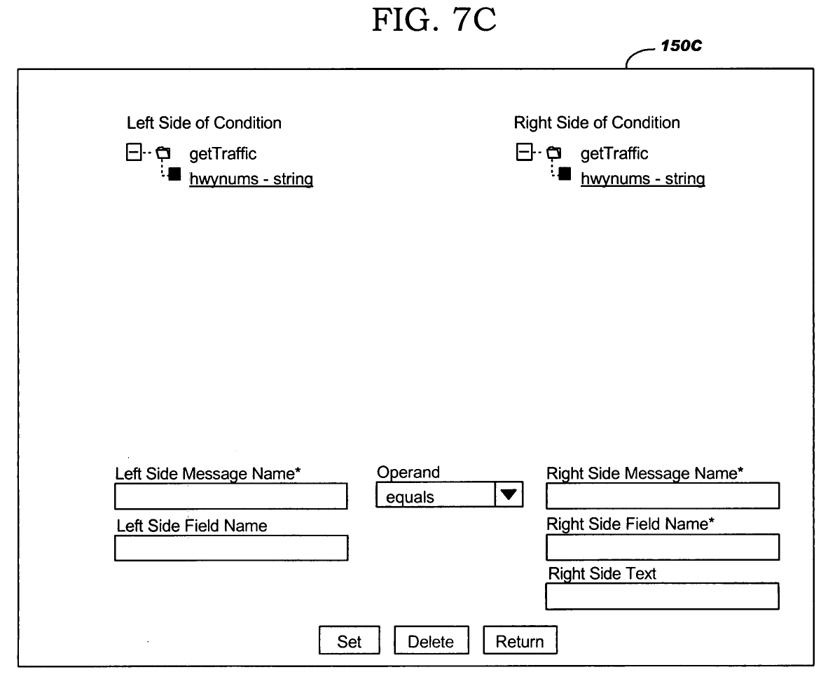

Referring to FIGS. 7A-7C, illustrative process configuration interface pages 150A-150C provided by the process configurator 38 are shown. The interface page 150A includes portlets 152 and 154. In general, the interface pages 150A-150C can be used to perform the following functions:

Creating a new process—In the portlet 152, the user selects “Create a new process” from the “Process Task” menu, enters a name to assign to the new process and a brief description in the “Name” and “Description” fields of the portlet 154, and specifies whether the process is to be enabled or disabled. The user also selects an input message and an output message from the corresponding pull down menus in the portlet 152 to associate with this process. The input and output messages provided in the pull down menus may be some or all of the input and output messages, respectively, that have been created using the message configurator 36. The user then clicks on the “Create” button to create the process.

The user then clicks on each desired service listed in the tree of the portlet 154 to add the selected service to the new process definition. The tree of the portlet 154 displays some or all of the services imported into the current line configuration version (i.e., the services imported using the service configurator 37). The user then clicks “Save” in portlet 152. The process configurator provides the ability to sequence the selected services in any desired order by the order of selection and by adding new services and removing existing ones. The name of each selected service will appear as a sequential listing in a list subportlet 156 of the portlet 152 along with its designated input and output messages (as discussed below). The assigned services can be deleted by clicking on the service name in the subportlet 156 and then clicking the “Delete” button. By default, the final step following the last service will be to “Reply” to the process point with the output message of the process.

For each service added to the process definition, the user must map the input attributes of the service. The GUI provides a mapping capability. The user may use the input message attributes of the process and the output message attributes of the preceding services to define this mapping. For each service, the user clicks on an assign variable icon (not shown) associated with that service. The system 14 will then display the interface page 150B (FIG. 7B). To map the attributes, the user clicks an attribute in the interface page 150B from the “Map From” list, whereupon the “Map From Message Name” and “Map From Message Field Name” fields are automatically filled. Alternatively, the user can type text in the “Map From Text” field instead of the “Map From Field Name” field. The user then clicks an attribute from the “Map To” list, whereupon the “Map To Message Name” and “Map to Field Name” fields are automatically filled. The user then clicks “Set”. The user repeats this process until all of the “Map To” fields are mapped. In the portlet 152A (FIG. 7A) an assign variable icon 153 is provided to indicate the mapping status of each service. If all of the “Map To” fields for a given service are mapped, all of the blocks of the icon 153 will be connected by horizontal lines; otherwise some of the blocks in the icon 153 will remain disconnected. Finally, the user will click “Return.”

The user may also set a condition that will determine whether a service will be invoked at run-time or not. The user can set a condition on an input parameter to a selected service so that the service will be started only when an input condition is met. This condition is a logical operation set on the value of an input attribute, or between the values of any two attributes. To make this setting, the user clicks a set condition icon 155 (in table 156; FIG. 7A), which opens the interface page 150C (FIG. 7C). The user then selects any parameter from the input messages listed on the left, whereupon the “Left Side Message Name” and “Left Side Field Name” fields are automatically filled. The user likewise selects a parameter from the input messages on the right and the corresponding fields are automatically filled. The user enters input in the right side text field, selects an operand, and finally clicks “Return” and then “Update”.

Updating an existing process—In the portlet 152, the user selects the process definition to be updated from the “Defined Processes” pull down menu. The user can only update the status (enabled or disabled) of the process (by toggling the “Enabled” box), the description of the process (by revising the description in the “Description” field of portlet 154), and/or the services contained in the process. The services can be updated in any of the ways as described above with regard to creating a new process (e.g., the user can disable the status of a service, update the conditional definition, update the mapping, re-order the service or delete the service). Once the desired revisions have been entered, the user clicks the “Update” button of the portlet 152.

According to some embodiments, by design, the user cannot change the input message or the output message associated with the selected process. Also, according to some embodiments, once a process has been linked to a process point it is not possible to update it. The process must be first detached (i.e., disassociated or deleted) from the process point before it can be updated.

Deleting a process—In the portlet 152, the user selects “Modify an existing process” from the “Process Task” menu and selects the process definition to be deleted from the “Defined Process” pull down menu. The user clicks on the “Delete” button of the portlet 152 to delete the selected process.

The “Reset” button of the portlet 152 can be used to clear the portlet 152 (i.e., deselect a selected process or clear data from the data entry fields).

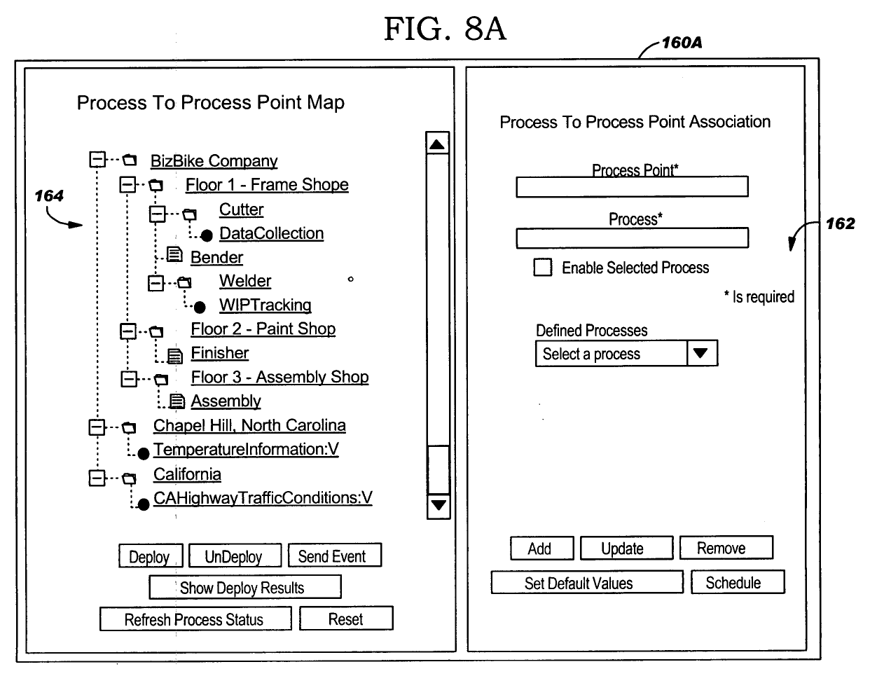

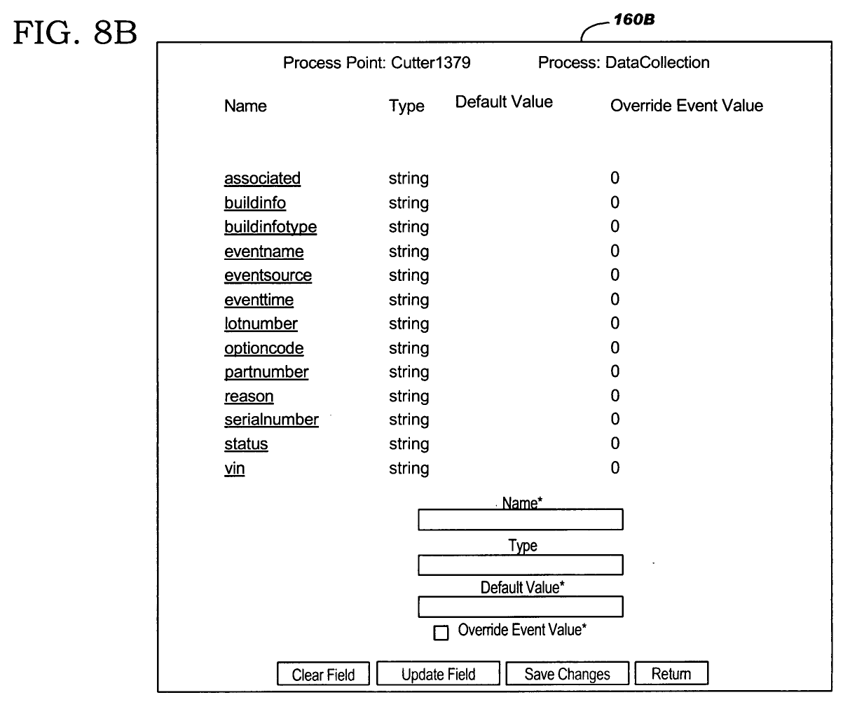

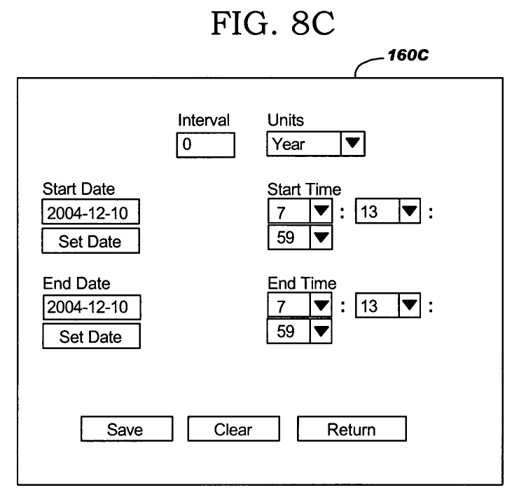

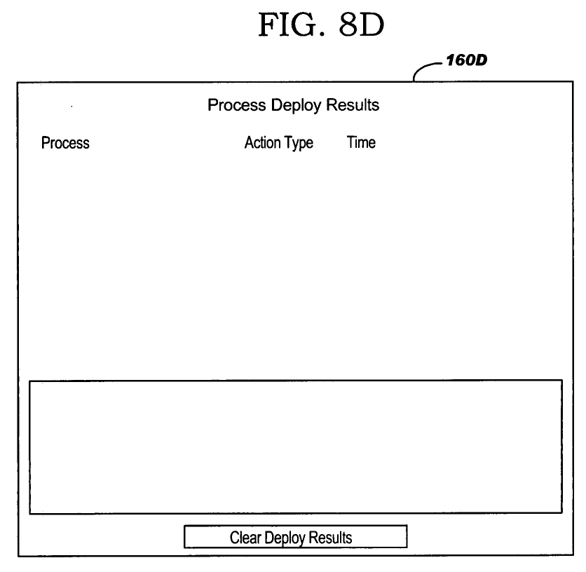

Referring to FIGS. 8A-8C, the process point configurator 39 allows the assembly line process points to be configured. The process point configurator 35 is used to associate process points with processes (to be invoked as a result of triggered events). This graphical representation can offer the flexibility to easily update or delete an existing process point configuration. Specifically, the process point configurator 39 provides a process point interface page to allow the associations between the process points and the processes to be performed at those process points to be defined.

Referring now to FIGS. 8A-8D, illustrative process point interface pages 160A, 160B, 160C, 160D are shown. The interface page 160 includes portlets 162 and 164. A line configuration tree is displayed in the portlet 164. The line configuration tree includes a listing of all of the process points of the line and all of the processes thus far associated with those process points. Using the interface pages 160A-D, the configuring user will define all the processes that will occur at each process point. The interface pages 160A-D allow the following functions to be performed:

Defining/updating a process point configuration—In the line configuration tree of the portlet 164, a user clicks on the process point node to be configured to select that process point. The process point name will be displayed in the “Process Point” field of the portlet 162. The user then selects a process from the “Defined Processes” pull down menu in the portlet 162, thereby attaching or associating the selected process to/with the selected process point. The name of the process will be displayed in the “Process” field in the portlet 162. The processes listed in the pull down menu may include some or all of the existing processes previously configured using the process configurator 38. There may be multiple processes associated with a process point. Using the “Enable/Disable Process at Process Point” box in the portlet 164, the user can selectively enable and disable a process associated with a process point so that the process will not be executed at the process point by the run-time engine 20 even if the process is deployed to the run-time engine 20 and triggered by an event. The user can choose whether to enable or disable the process using the block in the portlet 132. The user then clicks “Add” and the chosen process will appear under the selected process point in the tree of the portlet 162.

The configuration steps discussed above occur in the build-time engine and a process associated with a process point will not automatically become executable in the run-time engine 20 at the process point until the process is deployed using the “Deploy” button. A previously deployed process can be undeployed (i.e., rendered non-apparent to the run-time engine 20) by clicking on the process in the tree of the portlet 164 and then clicking the “Undeploy” button.

The user may set default values for the input attributes of a selected process associated with a process point by clicking the “Set Default Values” button in the portlet 162. In response, the interface page 160B (FIG. 8B) is generated, wherein the user can assign default values for the input attributes of this process at this process point in the event the values of the attribute fields are not sent. In the interface page 160B the user then clicks each attribute for which the user wants to set a default value, types the new value in the “Default Value” field, and clicks the “Update Field” button. This new value will be used with this attribute at run-time only if it does not have a value assigned to it when it is received. If the user wishes to force the attribute to have this value at run-time, the user can check the “Override Event Value” box. Finally, the user clicks “Save Changes”.

The user may schedule the process to be automatically triggered according to a schedule (e.g., at regular intervals) by clicking the “Schedule” button. In response, the interface page 160C (FIG. 8C) is generated, wherein the user can set the triggering schedule.

The user may also send a triggering event to the run-time engine for a selected process at the associated process point by selecting a process point and clicking the “Send Event” button in the portlet 164. This operation may used to for testing purposes, for example.

Deleting a process point configuration—The user clicks on a process attached to a process point node in the line configuration tree of the portlet 164 to select the process. The user then clicks on the “Remove” button in the portlet 162 to disassociate this process from the corresponding process point.

Broadly, and in summary, the user, via the configuration computer 12, creates or selects a working version of a line configuration using the version configurator 33. The user then designates process points in the line configuration using the tree configurator 35. The user then creates a catalog (or library) of input messages and a catalog of output messages using the message configurator 36. The user then creates a tree listing of service categories and a catalog (or library) of services using the services configurator 37, wherein each service is a Web Service and including specifying a URL from which to import a Web Service definition (e.g., WSDL document) for each service. The Web Service is imported via Internet transfer when the service is defined. The user next creates a catalog of processes using the process configurator 38, including defining the following for each process: a process input message, a process output message, a flow or sequence of services from the catalog of services, an input message for each such included service, and an output message for each such included service. This configuration of a process may include mapping the input attributes of an included service in the process flow from the process input message and/or from the output message(s) of any service(s) that are executed prior to said included service. This configuration of the process may also include the setting of conditions (logical operations based on input attributes values) that determine whether to invoke an included service at run-time or not. Then, using the process point configurator 39, the user assigns processes from the catalog of processes to the pre-designated process points. The system 10 also provides certain additional functionality as discussed herein via the process point configurator 39, such as the ability to: deploy or undeploy a process to the run-time engine; schedule a process to run automatically periodically; assign input default values to a process attached to a process point; and send test events to the run-time engine.

As the configuration procedure is being performed or thereafter, the configuration details (e.g., version, messages, services, processes, etc.) of the line configuration will be stored in one or more tables within the build-time storage unit 30 and/or the run-time database 21. Thus, the tables will include the process definitions and process-to-process point associations as needed to implement the line configuration. According to some embodiments, the configuration details are not loaded into the run-time database 21. However, according to other embodiments, some or all of the configuration details (e.g., the process definitions and/or the process-to-process point associations) are loaded into the run-time database 21. According to some embodiments and as described below, only the processes and the process points are loaded into the run-time database 21. Accordingly, the run-time database 21 will include the deployed process library but not the line configuration. The line configuration may thereafter be implemented as follows, with reference to an exemplary procedure.

An event is triggered at the process point 28A via the process point triggering device 26A (e.g., by the arrival of a vehicle at a specified process point). The event (or notification thereof) is communicated to the run-time engine 20 via the common device interface adapter 24A. The event notification includes various acquired data pertinent to the process to be executed at the process point. Typically, the event notification will include an identification of the process point and the process to be executed (or alternatively, data from which the run-time engine 20 can determine the appropriate process). Upon receipt, the run-time engine 20 may consult the line configuration (e.g., by reference to the tables in the build-time storage unit 30 or in cached information in the memory of the ALCC 18 that has been obtained from the build-time storage unit 30) and confirm that it is proper (i.e., per the line configuration) to execute the process at the process point where the event was triggered. If confirmed, the run-time engine 20 refers to the process library in the run-time database 21 to determine the services and other configuration details of the requested process (i.e., the process definition). The run-time engine 20 then invokes the process by invoking the flow of services included in the process definition as provided in the run-time database 21. Invoking each service includes: calling the Web Service (which may be internal or external) corresponding to the Web Service definition imported for that service; sending the designated input message, which may incorporate the aforementioned acquired pertinent event data, to the Web Service; receiving the output of the employed Web Service; incorporating said output into an output message of the service; and providing the service output message as the output message of the process and/or as an input message to another service. The run-time engine 20 invokes the services of the process in sequential order. Thus, for example, event “A,” could require process “B,” which is comprised of services “B1, B4, and B6” (in that order), to be performed to address the event. Once the process for addressing the event has been identified, the run-time engine 20 will invoke the process (i.e., the services thereof). The process generates an output or reply message which is communicated back to the process point 28A, stored in the build-time storage unit 30, the run-time database 21 or another local database system, communicated to another system, or any combination thereof. The contents of the reply message are defined at configuration time and may be a combination of output attributes from all executed services. The working unit (e.g., the vehicle) may then proceed to the next process point.

By way of further example, a process point may be set up at a paint station of an assembly line so that when a vehicle arrives there, it is painted correct colors based on build-order information for the vehicle. When the vehicle arrives at this point, an event notification is sent to the ALCC 18 requesting the information required for processing of the vehicle to continue. The ALCC 18 receives the event, confirms from the build-time storage unit 30 that the process is correlated with the process point, and invokes the process bound to this process point and in response to an event. The flow of services forming the process are sequentially invoked by the ALCC 18. The services are implemented by either internal or external Web Services. In this example, the ALCC 18 retrieves the information about what color the paint should be from the Web Service(s). The ALCC 18 then sends a message back to the plant floor instructing a painting station to paint the vehicle the correct color and to pass the vehicle to the next process point. At another process point, the process may include reading a serial number of the vehicle, forwarding the serial number to a Web Service to determine the information to be printed on a corresponding shipping order, and sending a message back to the process point instructing a printer to print the corresponding shipping order with the appropriate information.

It should be appreciated that the teachings of the present invention could be offered as a business method on a subscription or fee basis. For example, the configuration computer 12 of FIG. 1 could be created, maintained and/or deployed by a service provider that offers the functions described herein for customers. That is, a service provider could offer to test a server environment of a customer by driving a load and analyzing the resulting performance as describe above. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose configuration computer with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a configuration computer—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The build-time storage unit 30 and the run-time database 21 together form a storage system which may be modified in accordance with embodiments of the invention. According to some embodiments, the run-time database 21 is not used to store the process library in the run-time environment. Rather, the run-time engine 20 may refer to the table of the build-time storage unit 30 to retrieve the process definition information as well. Alternatively, according to further embodiments, the line configuration is also stored in the run-time database 21 so that the run-time engine 20 refers to the run-time database 21 for both process definitions and process-to-process point confirmations and the build-time storage unit 30 is not utilized in the run-time environment.

An exemplary data model is set forth below as Table 1. Table 1 lists all of the attribute definitions used by the line configuration services, which include version configuration services, tree configuration services, service import configuration services, message configuration services, process configuration services, and process point configuration services.

TABLE 1
Line Configuration Data Model

| | | |
|---|---|---|
| Attribute Name | Attribute Type | Description |

Tree Configurator sub-data
model

| | | |
|---|---|---|
| NodeId | INTEGER | Node identification |
| | | number |
| NodeName | VARCHAR(32) | Node name |
| LCName | VARCHAR(100) | Line configuration ver- |
| | | sion name |
| LCVersion | FLOAT(0) | Line configuration ver- |
| | | sion number |
| ParentNodeId | INTEGER | Parent node identification |
| | | number |
| Description | VARCHAR(256) | Description of node |
| Event process map sub-data | | |
| model | | |
| NodeId | INTEGER | Node identification |
| | | number |
| ProcessId | INTEGER | Process identification |
| | | number |
| ProcessPoint | VARCHAR(64) | Process point name |
| LCName | VARCHAR(100) | Line configuration ver- |
| | | sion name |
| LCVersion | FLOAT(0) | Line configuration ver- |
| | | sion number |
| Enabled | SAMLLINT | Status to indicate process |
| | | is enabled at process |
| | | point |
| StartDateTime | TIMESTAMP | Start date and time for |
| | | scheduled process |
| EndDateTime | TIMESTAMP | End date and time for |
| | | scheduled process |
| Period | INTEGER | Period to repeat the |
| | | trigger of the process |
| | | automatically |
| PeriodUnits | VARCHAR(32) | Units of the period |
| | | interval (hour, day, |
| | | week, etc) |

Line configuration version
sub-data model

| | | |
|---|---|---|
| LCName | VARCHAR(100) | Line configuration ver- |
| | | sion name |
| LCVersion | FLOAT(0) | Line configuration ver- |
| | | sion number |
| LCDescription | VARCHAR(256) | Line configuration |
| | | description |
| Service category sub-data | | |
| model | | |
| NodeId | INTEGER | Service category node ID |
| LCName | VARCHAR(100) | Line configuration ver- |
| | | sion name |
| LCVersion | FLOAT(0) | Line configuration ver- |
| | | sion number |
| NodeName | VARCHAR(32) | Service category node |
| | | name |
| ParentNodeId | INTEGER | Service category parent |
| | | node ID |
| Description | VARCHAR(256) | Description of the service |
| | | category node |
| Service definition sub-data | | |
| model | | |
| OriginalUrl | VARCHAR(256) | URL of the service to be |
| | | imported |
| NodeId | INTEGER | Service node ID |
| LCName | VARCHAR(100) | Line configuration ver- |
| | | sion name |
| LCVersion | FLOAT(0) | Line configuration ver- |
| | | sion number |
| ServiceName | VARCHAR(32) | Service node name |
| Description | VARCHAR(256) | Description of the service |
| | | node |
| ImportTimestamp | TIMESTAMP | Date and time of the |
| | | service import |
| Process definition sub-data | | |
| model | | |
| ProcessId | INTEGER | Process ID |
| Name | VARCHAR(32) | Process name |
| LCName | VARCHAR(100) | Line configuration ver- |
| | | sion name |
| LCVersion | FLOAT(0) | Line configuration ver- |
| | | sion number |
| Enabled | SMALLINT | Enabled or disabled |
| | | status of the process |
| Deployable | SMALLINT | Deployed or undeployed |
| | | status of the process |
| Description | VARCHAR(256) | Description of the |
| | | process |
| ProcessTemplate | VARCHAR(64) | |
| Event message sub-data | | |
| model | | |
| MsgId | INTEGER | Message ID |
| MsgType | VARCHAR(8) | Message type (input or |
| | | output) |
| ProcessId | INTEGER | |
| Message definition sub-data | | |
| model | | |

| | |
|---|---|
| MsgId | INTEGER |
| MsgName | VARCHAR(100) |
| MsgNameSpace | VARCHAR(256) |
| LCName | VARCHAR(32) |
| LCVersion | FLOAT(0) |
| Field definition sub-data | |
| model | |
| MsgId | INTEGER |
| FieldName | VARCHAR(100) |
| FieldType | VARCHAR(100) |
| FieldNameSpace | VARCHAR(256) |
| Mapping defaults | |
| NodeId | INTEGER |
| ProcessId | INTEGER |
| MsgId | INTEGER |
| FieldName | VARCHAR(100) |
| FieldValue | VARCHAR(256) |
| UseAlways | VARCHAR(1) |
| Service conditional | |
| execution sub-data model | |
| ProcessId | INTEGER |
| ActivityId | INTEGER |
| ParentId | INTEGER |
| PositionInParent | INTEGER |
| LeftMsgId | INTEGER |
| LeftFieldName | VARCHAR(100) |
| RightMsgId | INTEGER |
| RightFieldName | VARCHAR(100) |
| RightStaticText | VARCHAR(256) |

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

We claim:

1. A system for graphically and dynamically configuring an assembly line having process points where events can be triggered, the system comprising:
a service configurator for configuring services comprising imported Web Services; and
a process configurator for configuring processes to be implemented in response to triggered events at the process points, wherein each of the processes comprises a sequenced list of the services to be invoked in response to the triggered event.

2. The system of claim 1 wherein the service configurator imports Web Services definition documents for each of the Web Services.

3. The system of claim 1 further comprising a tree configurator for configuring the process points along the assembly line.

4. The system of claim 1 further comprising a process point configurator for associating the processes with the process points along the assembly line.

5. The system of claim 1 further comprising a message configurator for configuring input and output messages for the services and the processes.

6. The system of claim 1 further comprising a version configurator for selecting between at least:
creating a new assembly line for configuring; and
selecting a pre-existing assembly line for configuring.

7. The system of claim 1 further comprising a run-time engine that receives a triggered event from a process point, determines a corresponding process, and invokes the Web Services.

8. The system of claim 7 further comprising:
a build-time engine that implements the services configurator and the process configurator; and
a storage system that receives and stores a catalog of services and a catalog of processes from the build-time engine;
wherein the run-time engine accesses the storage system upon receiving the triggered event to determine the corresponding process and Web Services.

9. The system of claim 1 wherein the system is embodied within a graphical user interface.

10. The system of claim 1 further comprising:
a tree configurator for configuring the process points along the assembly line;
a process point configurator for associating the processes with the process points along the assembly line; and
a message configurator for configuring input and output messages for the services and the processes;
wherein the service configurator imports Web Services definition documents for each of the Web Services.

11. The system of claim 10 further comprising:
a run-time engine that receives a triggered event from a process point, determines a corresponding process, and invokes the Web Services;
a build-time engine that implements the services configurator, the process configurator, the tree configurator, the process point configurator, and the message configurator; and
a storage system that receives and stores a catalog of services, a catalog of processes and a catalog of input and output messages from the build-time engine;
wherein the system is embodied within a graphical user interface; and
wherein the run-time engine accesses the storage system upon receiving the triggered event to determine the corresponding process and Web Services.

12. The system of claim 10 further comprising a version configurator for selecting between at least:
creating a new assembly line for configuring; and
selecting a pre-existing assembly line for configuring.

13. The system of claim 1 wherein the process configurator comprises a deploy function to deploy the processes to a run-time engine.

14. A computer-implemented method for graphically and dynamically configuring an assembly line having process points where events can be triggered, the method comprising:
graphically configuring services including imported Web Services; and
graphically configuring processes to be implemented in response to triggered events at the process points, wherein each of the processes comprises a sequenced list of the services to be invoked in response to the triggered event.

15. The method of claim 14 wherein graphically configuring services including imported Web Services comprises importing Web Services definition documents for each of the Web Services.

16. The method of claim 14 further comprising graphically configuring the process points along the assembly line.

17. The method of claim 14 further comprising graphically associating the processes with the process points along the assembly line.

18. The method of claim 14 further comprising graphically configuring input and output messages for the services and the processes.

19. The method of claim 14 further comprising graphically selecting between at least:
creating a new assembly line for configuring; and
selecting a pre-existing assembly line for configuring.

20. The method of claim 14 further comprising receiving a triggered event from a process point, determining a corresponding process, and invoking the Web Services using a run-time engine.

21. The method of claim 20 further comprising:
storing a catalog of services and a catalog of processes in a storage system; and
using the run-time engine, accessing the storage system upon receiving the triggered event to determine the corresponding process and Web Services.

22. The method of claim 14 further comprising:
graphically configuring the process points along the assembly line;
graphically associating the processes with the process points along the assembly line; and
graphically configuring input and output messages for the services and the processes;
wherein graphically configuring services including imported Web Services comprises importing Web Services definition documents for each of the Web Services.

23. The method of claim 22 further comprising:
receiving a triggered event from a process point, determining a corresponding process, and invoking the Web Services using a run-time engine;
storing a catalog of services, a catalog of processes and a catalog of input and output messages in a storage system; and
using the run-time engine, accessing the storage system upon receiving the triggered event to determine the corresponding process and Web Services.

24. The method of claim 23 further graphically selecting between at least:
creating a new assembly line for configuring; and
selecting a pre-existing assembly line for configuring.

25. The method of claim 14 further comprising deploying the processes to a run-time engine.

26. A computer program product for graphically and dynamically configuring an assembly line having process points where events can be triggered, the computer program product comprising:
a computer readable medium having computer readable program code embodied therein, the computer readable program code comprising:
computer readable program code configured to configure services comprising imported Web Services; and
computer readable program code configured to configure processes to be implemented in response to triggered events at the process points, wherein each of the processes comprises a sequenced list of the services to be invoked in response to the triggered event.

27. A system for graphically and dynamically configuring an assembly line having process points where events can be triggered, the system comprising:
a version configurator for selecting between at least:
creating a new assembly line for configuring; and
selecting a pre-existing assembly line for configuring.
